(19) United States
(12) Patent Application Publication
(10) Pub. No.: US 2016/0372241 A1
(43) Pub. Date: Dec. 22, 2016

(54) METHOD AND STRUCTURE FOR WATERPROOFING WIRE HARNESS

(71) Applicant: Sumitomo Wiring Systems, Ltd., Yokkaichi (JP)

(72) Inventors: Masataka WAKABAYASHI, Yokkaichi (JP); Hiroyuki OOTSUKI, Yokkaichi (JP)

(21) Appl. No.: 15/184,275

(22) Filed: Jun. 16, 2016

(30) Foreign Application Priority Data
Jun. 18, 2015 (JP) 2015123020

(51) Int. Cl. H01B 13/32

(52) U.S. Cl. CPC H01B 13/322

(57) ABSTRACT

A method for waterproofing a wire harness that prevents dripping of a water blocking agent from a cap-like heat-shrinkable tube and stably ensures reliability of waterproofing. The method includes immersing exposed conductor portions in a water blocking agent inside a tube material with one end portion thereof closed, and heating, in this state, the tube material and the water blocking agent from outside to heat-cure the water blocking agent while heat-shrinking a heat-shrinkable tube so that the water blocking agent and the heat-shrinkable tube surround coating end portions. A heat-shrinkable cover material holding the tube material so that it can stand upright and surrounding a lower end portion side of the tube material is arranged to form an annular space inside the cover material in advance. During heating, the cover material and the tube material are integrally shrunk and are brought into contact with each other.

This Application claims the benefit of Japanese Application No. JP2015-123020, filed on Jun. 18, 2015, the contents of which are hereby incorporated by reference in their entirety.

### FIELD

The present invention relates to a method and a structure for waterproofing a wire harness, and particularly relates to a method and a structure for waterproofing a wire harness in which blocking of water in a space between elemental wires in an exposed conductor portion of an insulation-coated electric wire of the wire harness is performed.

### BACKGROUND

In wire harnesses that are installed in automobiles and the like, a splice portion is often formed in which a coating of an insulation-coated electric wire is partially stripped to expose a conductor composed of a group of elemental wires, and another wire is connected to that exposed conductor portion by resistance welding or by using a crimp terminal, or a connection terminal is crimped onto the exposed conductor portion.

In the case where an exposed conductor portion in such a splice portion is arranged in an area that may be exposed to water, it is required that the exposed conductor portion can be reliably waterproofed. Moreover, in the case where an end portion or another relatively exposed portion of a coated electric wire is arranged in an area that may be exposed to water, it is desirable that secondary exposure to water from that portion through spaces between elemental wires due to capillarity and the like can be prevented.

Thus, conventionally, a waterproofing method and a waterproofing structure have been proposed in which one open end portion of a heat-shrinkable tube is closed with a stopper to form a cap-like structure, a water blocking agent in liquid form is injected into the heat-shrinkable tube from the other end portion side, a splice portion is immersed in the water blocking agent, and in this state, the heat-shrinkable tube is heat-shrunk and the water blocking agent is heat-cured (see JP 2006-81319A1, for example).

However, in conventional waterproofing methods and waterproofing structures such as those described above, a water blocking agent is injected into a cap-like heat-shrinkable tube, only one end portion of which is heat-shrunk so as to be closed with a stopper, a splice portion is immersed in that water blocking agent, and in this state, heat shrinkage of the entire heat-shrinkable tube and heat-curing of the water blocking agent are advanced by heating from outside the heat-shrinkable tube.

Therefore, the diameter of one end portion of the heat-shrinkable tube that constitutes a lower end portion during injection of the water blocking agent is small, and the heat-shrinkable tube is likely to tip over. Thus, it is difficult to make the heat-shrinkable tube stand upright on its own during injection of the water blocking agent.

Also, in the case where an upper end portion of the cap-like heat-shrinkable tube and the coated electric wire near the upper end portion are guided so that the water blocking agent can be injected, since the heat-shrinkable tube that is likely to be inclined as described above is heated and heat-shrunk in the state in which the water blocking agent is injected into the heat-shrinkable tube and the splice portion is immersed in that water blocking agent, the guide becomes loose, and if heating from the outside is nonuniform, the inclination or deviation of the heat-shrinkable tube relative to the coated electric wire further increases during heat shrinkage of the heat-shrinkable tube.

For these reasons, with respect to conventional methods and structures for waterproofing a wire harness, there is concern that if the heat-shrinkable tube during heat shrinkage is significantly inclined, and heating from outside the heat-shrinkable tube becomes nonuniform, the level of the water blocking agent may rise at an early stage of the heat-shrinking stage of the heat-shrinkable tube, and lead to dripping of the water blocking agent from the upper end portion of the inclined heat-shrinkable tube. Thus, there is an unsolved problem of the decrease in reliability of waterproofing.

### SUMMARY

The present design was made to address a conventional problem such as that described above, and it is an object thereof to provide a method and a structure for waterproofing a wire harness, the method and the structure making it possible to reliably prevent dripping of a water blocking agent from a cap-like heat-shrinkable tube and stably ensure the reliability of waterproofing with the heat-shrinkable tube and the water blocking agent.

In order to achieve the above-described object, a method for waterproofing a wire harness is provided, the method including injecting a water blocking agent in liquid form into a heat-shrinkable tube with one end portion thereof closed, from another end portion side, immersing an exposed conductor portion of an insulation-coated electric wire in the injected water blocking agent in liquid form, and heating, in this state, the heat-shrinkable tube and the water blocking agent from outside the heat-shrinkable tube to heat-cure the water blocking agent while heat-shrinking the heat-shrinkable tube so that the water blocking agent and the heat-shrinkable tube surround a coating end portion of the coated electric wire, wherein a heat-shrinkable annular cover member holding the heat-shrinkable tube so that the heat-shrinkable tube can stand upright and surrounding the one end portion side of the heat-shrinkable tube is arranged to form an annular space surrounding the one end portion of the heat-shrinkable tube inside the annular cover member, and during heating of the heat-shrinkable tube and the water blocking agent from outside the heat-shrinkable tube, the annular cover member and the heat-shrinkable tube are heat-shrunk while the annular cover member is brought into contact with the heat-shrinkable tube.

With this configuration, the heat-shrinkable tube is held in the upright orientation by the annular cover member during injection of the water blocking agent, and the annular space that can circumferentially uniformly keep and transfer the heat resulting from heating from outside the heat-shrinkable tube is formed inside the annular cover member. Therefore, during heating from outside the heat-shrinkable tube, the annular cover member and the heat-shrinkable tube are integrally heat-shrunk, and during heat shrinkage of the heat-shrinkable tube and heat-curing of the water blocking agent, the speed of shrinkage and curing of the entirety of the heat-shrinkable tube and the water blocking agent is stabilized. Thus, the occurrence of dripping is effectively suppressed.

In the method for waterproofing a wire harness, it is possible to use a two-part thermosetting epoxy resin as the water blocking agent. With this configuration, the effect of promoting heat-curing by the two-part thermosetting epoxy resin generating heat can be enhanced by the heat keeping effect in the annular space.

A structure for waterproofing a wire harness is also provided, the structure comprising a tubular protective member and a resin material, the tubular protective member accommodating an exposed conductor portion of an insulation-coated electric wire together with a coating end portion adjacent to the exposed conductor portion, and the resin material being cured in a bottomed tubular shape in a state in which the resin material covers the exposed conductor portion and the coating end portion while being accommodated in the protective member, wherein the protective member is constituted by a heat-shrinkable tube that is shrunk to a predetermined shrink diameter and that is closed at one end side by a stopper, the resin material is formed of a thermosetting resin that is cured between the protective member and the coated electric wire while coming into intimate contact with the stopper and a pair of said coating end portions adjacent to the exposed conductor portion, and an annular cover member is provided on the one end portion side of the heat-shrinkable tube, the annular cover member being integrally heat-shrunk with the heat-shrinkable tube so as to form an annular space that surrounds the one end portion of the heat-shrinkable tube, while holding the heat-shrinkable tube so that the heat-shrinkable tube can stand upright.

With this configuration, the heat-shrinkable tube to which the annular cover member is attached can stand upright on its own. Furthermore, the heat-shrinkable tube is held in the upright orientation by the annular cover member even before curing of the water blocking agent, and the annular space that can circumferentially uniformly keep and transfer the heat resulting from heating from outside the heat-shrinkable tube is formed inside the annular cover member. Thus, during heating from outside the heat-shrinkable tube, the annular cover member and the heat-shrinkable tube are integrally heat-shrunk, and the speed of heat shrinkage of the heat-shrinkable tube and heat-curing of the water blocking agent is stabilized. As a result, a waterproofing structure of stable quality is obtained.

Moreover, it is preferable that the heat-shrinkable tube is formed such that a width of the annular space in a radial direction becomes smaller on an upper end side of the annular cover member and larger on a lower end side of the annular cover member.

With this configuration, the effect of promoting heat-curing by the two-part thermosetting epoxy resin generating heat is enhanced by the heat keeping effect in the annular space, and the mechanism in which the heat-shrinkable tube is held in the upright orientation and prevented from tipping over by the annular cover member is improved.

Accordingly, it possible to provide a method and a structure for waterproofing a wire harness, the method and the structure making it possible to reliably prevent dripping of a water blocking agent from a cap-like heat-shrinkable tube and stably ensure the reliability of waterproofing with the heat-shrinkable tube and the water blocking agent.

### DRAWINGS

FIG. 1 is a vertical cross-sectional view of a splice portion of a structure for waterproofing a wire harness according to a first embodiment and shows the waterproofing structure.

FIG. 2 is a diagram for explaining a stage of creating the splice portion by connecting exposed conductor portions of a plurality of electric wires by crimping, the stage constituting a preliminary step of a method for waterproofing a wire harness according to the first embodiment.

FIG. 3 is a diagram for explaining a stage of attaching a stopper to one end portion of a heat-shrinkable tube, the stage constituting a preliminary step of the method for waterproofing a wire harness according to the first embodiment.

FIGS. 4A and 4B are diagrams for explaining an orientation of a waterproofing target portion at the start of heating, the waterproofing target portion being in a state in which after a heat-shrinkable annular cover member is attached to the heat-shrinkable tube prepared by the preliminary steps of the method for waterproofing a wire harness according to the first embodiment, a water blocking agent is injected into the heat-shrinkable tube and the splice portion is immersed in the water blocking agent, where FIG. 4A is a side cross-sectional view of the waterproofing target portion, and FIG. 4B is a bottom view of the waterproofing target portion in the heating orientation.

FIGS. 5A and 5B are diagrams for explaining a first half stage of a heating step, of the method for waterproofing a wire harness according to the first embodiment, in which heating for heat-shrinking the heat-shrinkable tube and heat-curing the water blocking agent is performed from an arrangement-completed state before heating.

FIGS. 6A and 6B are diagrams for explaining a second half stage of the heating step of the method for waterproofing a wire harness according to the first embodiment.

FIG. 7 is a horizontal cross-sectional view of a coated electric wire of the structure for waterproofing a wire harness according to the first embodiment and shows the waterproofing structure.

FIG. 8 is a vertical cross-sectional view of a relevant portion of a structure for waterproofing a splice portion of a wire harness according to a second embodiment and shows the waterproofing structure.

FIGS. 9A and 9B are diagrams for explaining an arrangement-completed state immediately before heating, in which after a heat-shrinkable annular cover member is attached to a circumference of a lower end side of a heat-shrinkable tube prepared by a preliminary step of a method for waterproofing a wire harness according to the second embodiment, a thermosetting water blocking agent is injected into the inside of the heat-shrinkable tube and the splice portion is immersed in the water blocking agent, and in this state, the heat-shrinkable tube is arranged in a heating environment for heat-curing the water blocking agent.

FIGS. 10A and 10B are diagrams for explaining a first half stage of a heating step, of the method for waterproofing a wire harness according to the second embodiment, in which heating for heat-shrinking the heat-shrinkable tube and heat-curing the water blocking agent is performed from the arrangement-completed state before heating.

### DESCRIPTION

Hereinafter, embodiments of the present invention will be described with reference to the drawings.

### First Embodiment

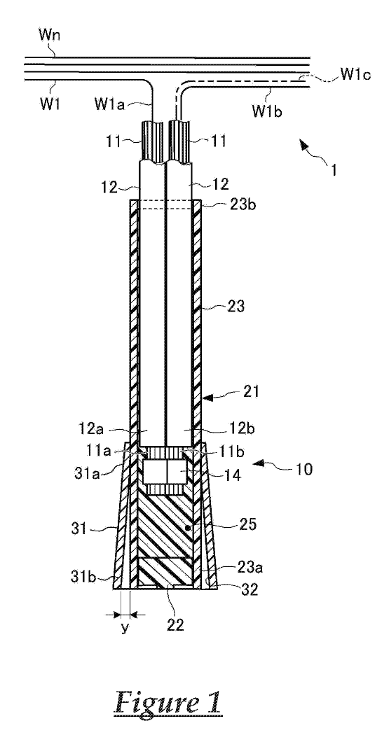

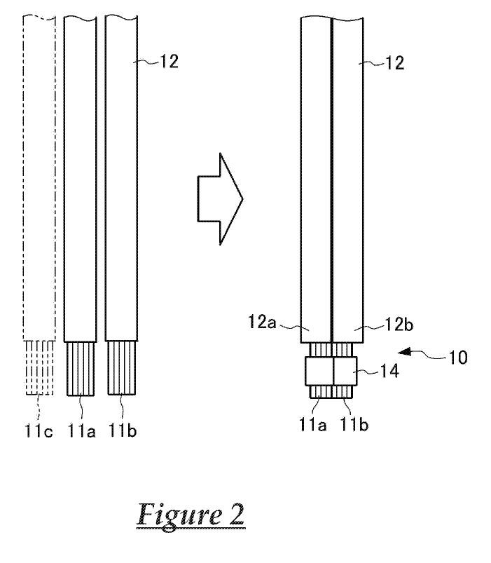

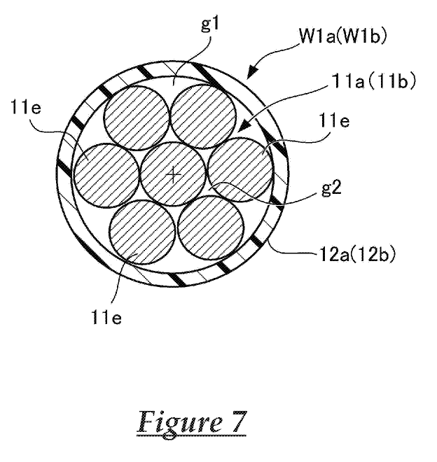

FIG. 1 shows a first embodiment in which a structure for waterproofing a wire harness is applied to a splice portion. FIGS. 2 to 6B illustrate a method for waterproofing a wire harness according to the first embodiment. FIG. 7 shows a horizontal cross-sectional view of a coated electric wire constituting the wire harness. In the first embodiment, waterproofing is applied to a wire harness for use in vehicles, and in particular, waterproofing of a splice portion of the wire harness and blocking of water in spaces between elemental wires in the splice portion are performed.

First, a configuration of the present embodiment will be described.

As shown in FIG. 1, the structure for waterproofing a wire harness of the present embodiment is provided on a coated electric wire W1 of a wire harness 1 having a plurality of insulation-coated electric wires W1 to Wn (“n” is a natural number of 2 or more). This coated electric wire W1 has a coated electric wire W1a on one side and a coated electric wire W1b on the other side, the coated electric wires W1a and W1b being connected to each other via a splice portion 10, which is a connecting portion. The splice portion 10 has a crimp terminal 14, for example.

It should be noted that although the two coated electric wires W1a and W1b on the one side and the other side, respectively, are given in the following description for the sake of convenience, the coated electric wire W1a on the one side and the coated electric wire W1b on the other side may both be a plurality of coated electric wires, and as indicated by the phantom line in FIG. 1, for example, a coated electric wire W1c on the other side may also be provided in addition to the coated electric wire W1b on the other side. Naturally, the coated electric wire W1a on the one side may be constituted by a plurality of coated electric wires, or the plurality of coated electric wires on the one side or the other side may be constituted by a large number of coated electric wires.

The coated electric wire W1a on the one side and the coated electric wire W1b on the other side (hereinafter also referred to as the coated electric wires W1a and W1b ) are each constituted by a conductor 11 composed of a plurality of elemental wires that are bundled together and a coating tube 12 concentrically surrounding the conductor 11.

The conductor 11 is composed of, for example, a circular stranded wire obtained by twisting together a plurality of elemental wires, which are soft copper wires. However, the conductor 11 may also be a single conducting wire. Moreover, the coating tube 12 is composed of a coating material that is made of a resin mainly composed of vinyl chloride resin, for example, and that has a circular cross sectional shape.

In the splice portion 10 of the coated electric wire W1, an end portion 12a on the one side and an end portion 12b on the other side, of the coating tubes 12 are stripped so as to be removed within a predetermined length range, and thus an exposed conductor portion 11a on the one side and an exposed conductor portion 11b on the other side are provided, in each of which a portion of the conductor 11 is exposed to the outside of the coating tube 12. Hereinafter, the exposed conductor portion 11a on the one side and the exposed conductor portion 11b on the other side in the splice portion 10 are simply referred to as the exposed conductor portions 11a and 11b, and the end portion 12a on the one side and the end portion 12b on the other side that are adjacent to the respective exposed conductor portions 11a and 11b are simply referred to as the coating end portions 12a and 12b.

The exposed conductor portions 11a and 11b together with the coating end portions 12a and 12b (end portions of the coating adjacent thereto) are accommodated in the inside of a substantially bottomed cylindrical protective member 21 for insulation, heat resistance, and mechanical protection.

A resin material 25 is provided inside the protective member 21, the resin material 25 being configured to cure in a substantially cylindrical shape in a state in which the exposed conductor portions 11a and 11b and the coating end portions 12a and 12b are covered with the resin material 25, and function as a water blocking agent. This resin material 25 has a larger outer diameter than the coating tubes 12 and a larger length in an axial direction than the exposed conductor portions 11a and 11b. Moreover, the protective member 21 has a larger outer diameter and a larger length in the axial direction than the resin material 25.

On the other hand, the protective member 21 is constituted by a stopper 22 that is arranged opposing one end side of the exposed conductor portions 11a and 11b and a heat-shrinkable tube 23 that is shrunk to a predetermined shrink diameter and whose inner circumference on one end portion 23a side is in intimate contact with the stopper 22. The heat-shrinkable tube as used herein refers to a resin tube that is to be shrunk in a radial direction by heating, and is produced by cutting a long tube.

Moreover, the resin material 25 is formed of a thermosetting resin, the thermosetting resin being cured between the protective member 21 and the coated electric wires W1a and W1b while coming into intimate contact with the stopper 22, the exposed conductor portions 11a and 11b, and the plurality of coating end portions 12a and 12b. Specifically, the resin material 25 is cured while adhering to the heat-shrinkable tube 23 and the stopper 22 so as to adhere the end portion 23a of the heat-shrinkable tube 23 and the stopper 22 to each other, the stopper 22 being in intimate contact with the inner circumference of the end portion 23a with a predetermined interference.

The stopper 22 is formed of polypropylene (PP) or polyethylene (PE), which are polyolefin resins, for example. The heat-shrinkable tube 23 is formed of a polyolefin resin, for example, polypropylene (PP) or polyethylene (PE), that can come into intimate contact with the outer circumference of the stopper 22 by heat shrinkage and preferably can be expected to have heat sealing properties. The heat-shrinkable tube 23 is a known heat-shrinkable tube whose inner diameter after heat shrinkage is a shrink diameter of, generally, about half of its inner diameter before heat shrinkage, and the heat-shrinkable tube 23 has been shrunk to a predetermined shrink diameter.

The resin material 25 is formed of a cured layer obtained by heat-curing a two-part, low-viscosity, thermosetting epoxy resin, for example. Low viscosity as used herein means a degree of viscosity (e.g., 100 mPa·s (millipascal seconds) or less) that allows the two-part thermosetting epoxy resin having flowability before heat-curing to come into highly intimate contact with the perimeter of the exposed conductor portions 11a and 11b and easily penetrate gaps in the coating end portions 12a and 12b of the coating tubes 12. It should, however, be noted that in the case where a step of causing the water blocking agent before heat-curing to penetrate between the elemental wires in the exposed conductor portions 11a and 11b is separately provided or in the case where blocking of water in spaces between the elemental wires is not necessary, the epoxy resin in which the exposed conductor portions 11a and 11b are immersed may have a moderately high viscosity.

The resin material 25 is cured between the protective member 21 and the coated electric wire W1 while coming into intimate contact with the stopper 22 and the heat-shrinkable tube 23 and penetrating the gaps in the two coating end portions 12a and 12b, the gaps being formed between each coating end portion 12a or 12b and the corresponding exposed conductor portion 11a or 11b. That is to say, the resin material 25 is cured in a substantially bottomed tubular shape in a state in which the resin material 25 covers the exposed conductor portions 11a and 11b and the coating end portions 12a and 12b of the coating tubes 12 while being accommodated in the protective member 21.

The gaps in the coating end portions 12a and 12b of the coating tubes 12 refer to the gaps between each exposed conductor portion 11a or 11b and the corresponding coating end portion 12a or 12b, and the gaps include at least gaps g1 (see FIG. 7) that are formed between adjacent elemental wires 11e near the inner circumference of the coating end portions 12a and 12b of the respective coating tubes 12 and may also include gaps g2 in the exposed conductor portions 11a and 11b.

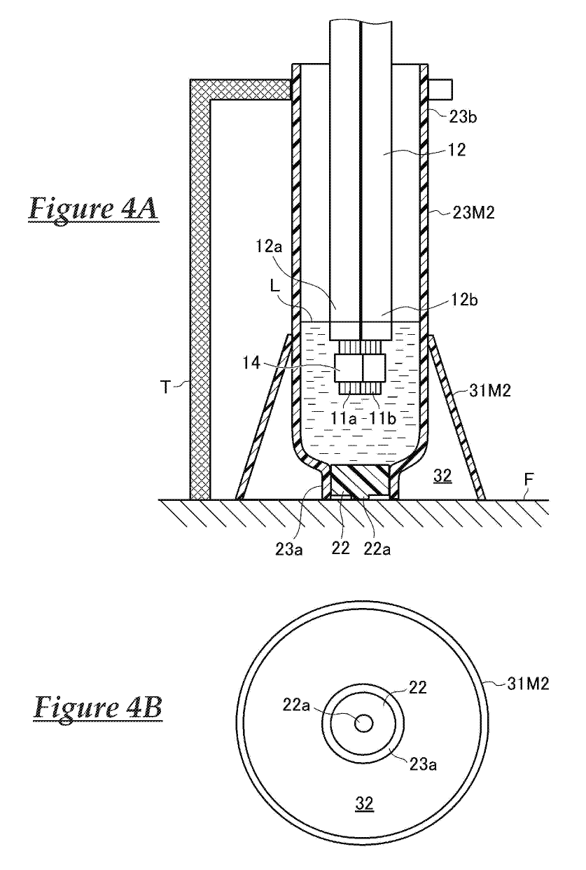

On the other hand, an annular cover member 31 is provided on the end portion 23a side of the heat-shrinkable tube 23, and the annular cover member 31 holds the heat-shrinkable tube 23 so that the heat-shrinkable tube 23 can stand upright on an installation surface F at the start of the waterproofing as shown in FIG. 4A.

The annular cover member 31 is a heat-shrinkable member whose upper end portion 31a has been integrally heat-shrunk with the heat-shrinkable tube 23, and is made of a material having the same heat shrinkage ratio as the heat-shrinkable tube 23. That is to say, the annular cover member 31 is formed of a resin that can be integrally heat-shrunk with the heat-shrinkable tube 23 during heat shrinkage while remaining in intimate contact with the outer circumference of the heat-shrinkable tube 23, and for example, the annular cover member 31 is formed of a polyolefin resin that can be expected to have heat sealing properties. This annular cover member 31 is obtained by shrinking a material whose inner diameter after heat shrinkage is a shrink diameter of, generally, about half of its inner diameter before heat shrinkage to a predetermined shrink diameter.

The annular cover member 31 has a skirt-like shape, that is, the shape of the circumferential wall of a truncated cone, in which the outer diameter of the annular cover member 31 increases toward a lower end portion 31b. An annular space 32 surrounding the end portion 23a of the heat-shrinkable tube 23 and having a small thickness in the radial direction is formed on an inner side of the annular cover member 31.

The angle formed by the outer circumferential surface of the heat-shrinkable tube 23 and the inner circumferential surface of the annular cover member 31 is less than 45 degrees. Moreover, the heat-shrinkable tube 23 and the annular cover member 31 are formed such that a width “y” of the annular space 32 in the radial direction is smaller on the upper end portion 31a side of the annular cover member 31 and larger on the lower end portion 31b side of the annular cover member 31.

It is also possible to remove the annular cover member 31 from the splice portion 10 after the waterproofing, which will be described later. It goes without saying that in that case, the annular cover member 31 is not required to be a member that can be expected to have heat sealing properties with respect to the heat-shrinkable tube 23 during heat shrinkage.

Next, an example of the method for waterproofing a wire harness according to the present embodiment will be described.

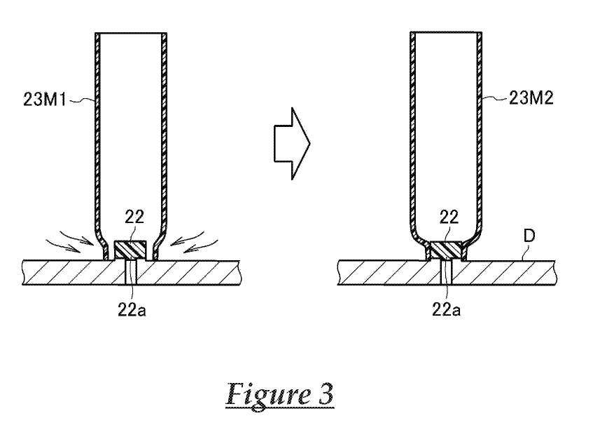

First, in a preliminary stage, as shown in FIG. 2, the exposed conductor portions 11 a and 1 lb of at least the coated electric wires W1a and W1b are connected by crimping using the crimp terminal 14. Moreover, as shown in FIG. 3, the stopper 22 is positioned on a workbench D or arranged thereon in a substantially positioned state, and a tube material 23M1 before heat shrinkage, which is the material for the heat-shrinkable tube 23, is arranged so as to surround the stopper 22.

An annular protrusion 22a for temporal positioning may also be formed in a central portion of the stopper 22 on one surface side, and a seat for keeping the stopper 22 in a fixed orientation while substantially positioning the annular protrusion 22a may also be formed on the workbench D. It goes without saying that a configuration may also be employed in which the stopper 22 is not provided with the annular protrusion 22a and the upper surface of the workbench D is a horizontal flat surface.

Then, a lower end portion of the tube material 23M1 on the workbench D is heated by hot air so that the lower end portion of the tube material 23M1 within a range corresponding to the height of the stopper 22 is heat-shrunk. At this time, it is also possible to use a guide or the like that controls the flow of air so as to restrict the range to be heated by hot air.

Heating by hot air is performed until a state is reached under which the lower end portion of the tube material 23M1 has been heat-shrunk to a state in which it is heat-sealed while coming into intimate contact with the entire outer circumferential surface of the stopper 22, and then, the tube material 23M1 is naturally cooled. Thus, a tube material 23M2 into which the stopper 22 is integrated is completed.

Then, a cover material 31M2, which is the material for the annular cover member 31 before heat shrinkage, is attached to the tube material 23M2 so as to hold the tube material 23M2 so that the tube material 23M2 can stand upright on the installation surface F during heating.

The cover material 31M2 is formed in the shape of the circumferential wall of a truncated cone in a pre-molding stage so that one end portion of the cover material 31M2 in the axial direction has such an inner diameter that allows the one end portion to be fitted to the tube material 23M2 in a slightly tightened state or to be slidably fitted to the tube material 23M2, and the other end portion of the cover material 31M2 in the axial direction has a larger diameter than the one end portion. It is also possible to form a cylindrical inner circumferential surface in a fitting portion of the cover material 31M2 that is fitted to the tube material 23M2.

Then, as shown in FIG. 4A, the tube material 23M2 to which the cover material 31M2 has been attached is placed on a stand T having the installation surface F that can be arranged in a heating environment. FIG. 4B is a bottom view of the tube material 23M2 at this time, to which the cover material 31M2 has been attached.

The stand T is a movable stand that is arranged such that the installation surface F is horizontal. The stand T is configured to be able to guide upper end portions of a plurality of tube materials 23M2, or alternatively a plurality of sets of coated electric wires W1a and W1b, within a predetermined range in a horizontal direction using its upper end portion that is parallel to the installation surface F.

Then, a preset injection amount of two-part thermosetting epoxy resin L (hereinafter also referred to as the resin solution L) in liquid form is injected into the tube material 23M2, which is placed on the stand T, from the upper end side of the tube material 23M2.

Then, the exposed conductor portions 11a and 11b of the coated electric wires

W1a and W1b that are connected by crimping using the crimp terminal 14 as well as the coating end portions 12a and 12b adjacent to the coated electric wires W1a and W1b are immersed in the resin solution L inside the tube material 23M2. The aforementioned injection amount is set such that the resin solution L at this time is at such a level that allows the coating end portions 12a and 12b to be immersed to a predetermined depth.

Then, in order to advance heat shrinkage of the tube material 23M2 placed on the stand T and heat-curing of the injected resin solution L, the tube material 23M2 and the resin solution L are heated to a predetermined temperature by hot air from outside the tube material 23M2 in a material arrangement completed state in which the exposed conductor portions 11a and 11b of the coated electric wires W1a and W1b as well as the coating end portions 12a and 12b are immersed in the resin solution L. Alternatively, the tube material 23M2 placed on the stand T in the material arrangement completed state is inserted into and moved in a heating environment, and in this manner the tube material 23M2 and the resin solution L are heated to the predetermined temperature from outside the tube material 23M2.

The predetermined temperature here is a heat shrinkage temperature at which the heat shrinkage ratio of the tube material 23M2 reaches a predetermined shrinkage ratio that has been set in advance. However, it is also possible to change the heating temperature in accordance with the heat-curing time of the resin solution L so that the heat shrinkage ratio gradually increases within a temperature range in which the tube material 23M2 can be heat-shrunk.

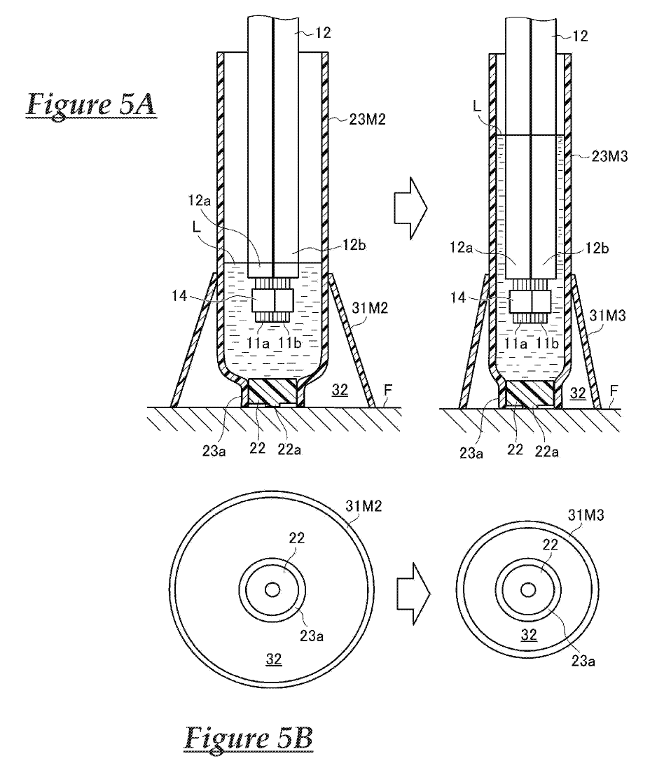

In this state, the tube material 23M2 is heat-shrunk such that the diameter of the entire tube material 23M2 is reduced, and the level of the resin solution L rises. That is to say, as the heat shrinkage of the tube material 23M2 advances, the level of the resin solution L rises as shown in FIG. 5A. Also, as shown in FIGS. 5A and 5B, the tube material 23M2 and the cover material 31M2 become a tube material 23M3 and a cover material 31M3 having smaller diameters than the tube material 23M2 and the cover material 31M2 due to heat shrinkage, and the diameter of the annular space 32, which is formed between these materials, is also reduced.

Moreover, at this time, the resin solution L, which is the two-part thermosetting epoxy resin, generates heat due to a base resin and a curing agent of the resin solution L itself reacting with each other, and is also heated from the outside. Accordingly, heat- curing of the resin solution L of the thermosetting epoxy resin starts advancing.

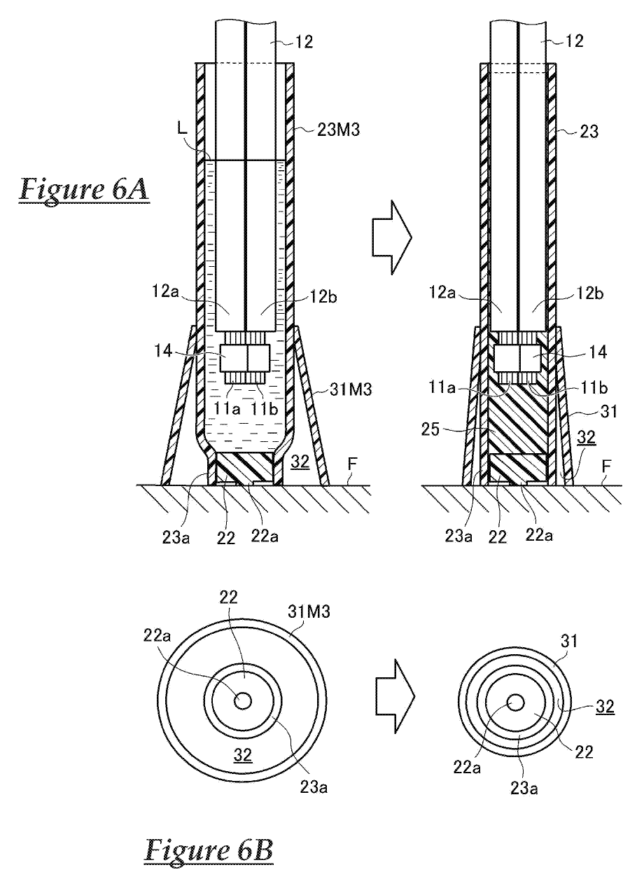

When heat shrinkage of the tube material 23M3 and heat-curing of the resin solution L further advance, the level of the resin solution L further rises as shown in FIG. 6A, and after that, heat-curing of the resin solution L advances. Moreover, as shown in FIGS. 6A and 6B, the diameters of the tube material 23M3 and the cover material 31M3 are further reduced due to heat shrinkage, and the diameter of the annular space 32, which is formed between these materials, is also further reduced.

Then, after a preset heating time has elapsed, the heat-shrinkable tube 23 with the stopper 22 after heat shrinkage as well as the resin material 25 having the function of a water blocking agent for waterproofing the splice portion 10 inside the heat-shrinkable tube 23 are completed.

As described above, in the heating stage of advancing heat shrinkage of the tube material 23M2 placed on the stand T and heat-curing of the resin solution L injected into that tube material 23M2, the upper end portion of the cover material 31M2 to be heat-shrunk is kept in contact with the outer circumferential surface of the tube material 23M2 to be heat-shrunk, the tube material 23M2 being made of the same heat-shrinkable material as the cover material 31M2. That is to say, the tube material 23M2 and the cover material 31M2 are integrally heat-shrunk by heating from outside these materials.

Accordingly, the cover material 31M2, which is the material for the annular cover member 31, accurately keeps the vertically upright orientation of the tube material 23M2, which is the material for the heat-shrinkable tube 23, thereby preventing the tube material 23M2 from being significantly inclined during heat shrinkage.

Furthermore, in this heating stage, not only the vertically upright orientation of the tube material 23M2 is accurately kept, but also the annular space 32 that can circumferentially uniformly keep and transfer the heat resulting from heating from outside the tube material 23M2 is formed inside the cover material 31M2. Thus, during heat shrinkage of the tube material 23M2 and heat-curing of the resin solution L, the speed of shrinkage and curing of the entirety of the tube material 23M2 and the resin solution L is stabilized.

Therefore, even if heating from outside the tube material 23M2, which is the material for the heat-shrinkable tube, becomes nonuniform, the occurrence of a situation in which the lower end portion of the tube material 23M2 is significantly heat-shrunk first, causing a rise in the level of the resin solution L at an early stage in the heat-shrinking stage, and a situation in which the resin solution L drips from the upper end portion of the inclined tube material 23M2 can be reliably prevented.

These points also hold true for the heating stage in which heat shrinkage of the tube material 23M3 placed on the stand T and heat-curing of the resin solution L inside the tube material 23M3 are further advanced. As a result, the occurrence of a situation in which curing is performed in a state in which a portion of the resin material 25 is dripping to an upper portion of the completed heat-shrinkable tube 23 is prevented. Thus, the reliability of waterproofing of the splice portion 10 is stably ensured.

In this manner, according to the present embodiment, it is possible to provide a method and a structure for waterproofing a wire harness, the method and the structure making it possible to reliably prevent dripping of the resin solution L of the water blocking agent from the cap-like heat-shrinkable tube 23 and stably ensure the reliability of waterproofing with the heat-shrinkable tube 23 and the resin material 25, which is a heat-cured layer of the water blocking agent.

Furthermore, according to the present embodiment, since the resin solution L, which is a two-part thermosetting epoxy resin, is used as the water blocking agent, the heat-curing promoting effect that is provided by the resin solution L generating heat can be enhanced by the heat keeping effect in the annular space 32, and thus the time required for waterproofing can be reduced.

In the case where the annular cover member 31 is ultimately removed, the heat-shrinkable tube 23 can be pulled out from the annular cover member 31 after heat shrinkage, or the annular cover member 31 after heat shrinkage can be torn and stripped off the heat-shrinkable tube 23.

### Second Embodiment

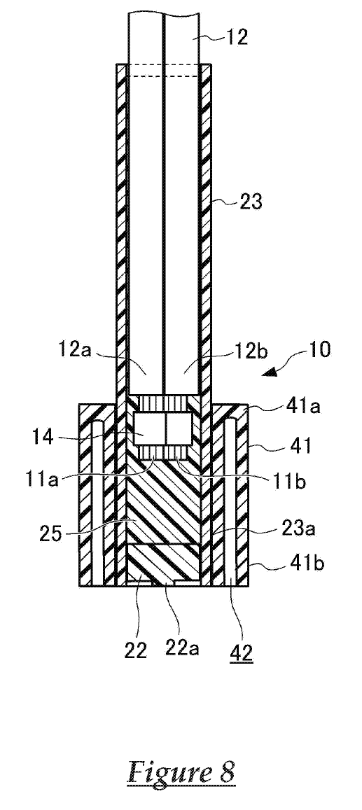

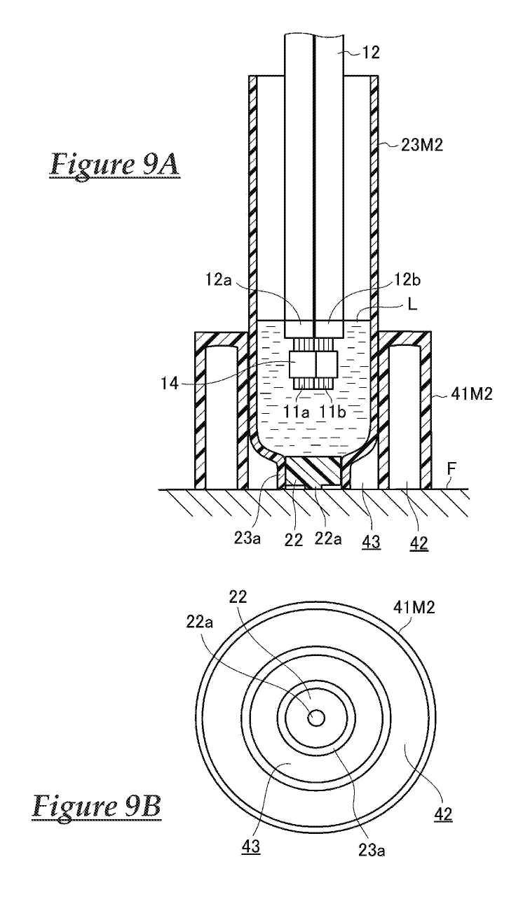

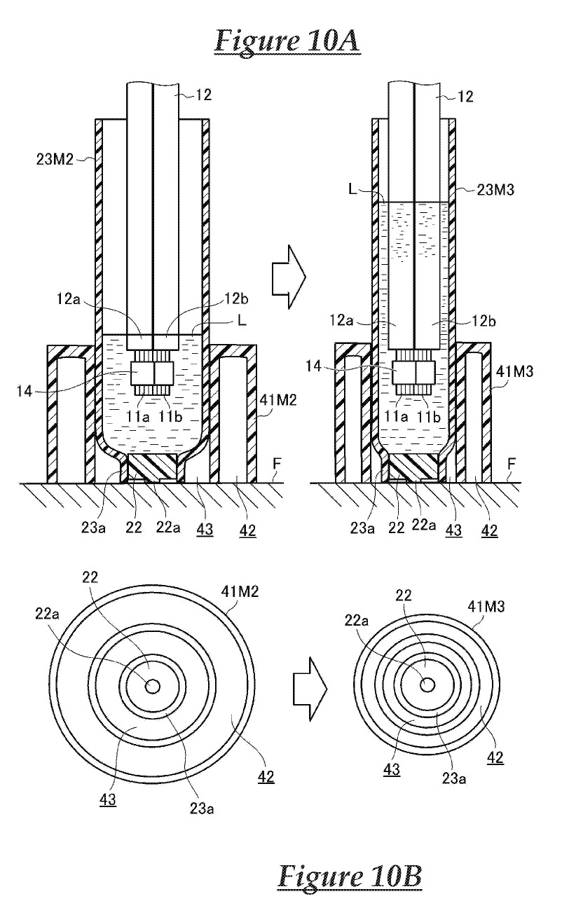

FIG. 8 shows a second embodiment in which the structure for waterproofing a wire harness is applied to the splice portion. FIGS. 9A to 10B illustrate a method for waterproofing a wire harness according to the second embodiment. In the structure for waterproofing a wire harness according to the second embodiment, the annular cover member 31 of the first embodiment is replaced by an annular cover member 41 whose inner and outer circumferential surfaces have the shape of a straight cylindrical surface, and the second embodiment is different from the first embodiment in this respect. However, otherwise, the configuration of the second embodiment is the same as or similar to that of the first embodiment. Accordingly, with respect to the configuration that is the same as or similar to that of the first embodiment, reference numerals of the corresponding components shown in FIGS. 1 to 7 are used, and the following gives a description of the difference from the first embodiment.

In the above-described first embodiment, the cover material 31M2 that inclines in the form of a skirt is attached to the tube material 23M2 in the material arrangement completed state, and then heating is performed. Thus, the annular cover member 31 is attached to the splice portion 10 after waterproofing.

The annular cover member 41 is a heat-shrinkable member that has been integrally heat-shrunk with the heat-shrinkable tube 23, and is made of a material having the same heat shrinkage ratio as the heat-shrinkable tube 23. This annular cover member 41 has a substantially U-shaped cross section with its double cylindrical walls, that is, inner and outer walls, being connected to each other on an upper end portion 41a side and concentrically separated from each other on a lower end portion 41b side. Moreover, at least an inner circumferential surface on the upper end side, for example, the entire inner circumferential surface, of the annular cover member 41 is in intimate contact with the outer circumferential surface of the heat-shrinkable tube 23.

This annular cover member 41 is also formed of a resin that can be integrally heat-shrunk with the heat-shrinkable tube 23 during heat shrinkage while remaining in intimate contact with the outer circumference of the heat-shrinkable tube 23, and for example, the annular cover member 41 is formed of a polyolefin resin that can be expected to have heat sealing properties. Moreover, the annular cover member 41 is obtained by shrinking a material whose inner diameter after heat shrinkage is a shrink diameter of, generally, about half of its inner diameter before heat shrinkage, to a predetermined shrink diameter.

The annular cover member 41 forms an annular space 42 on its inner side. The annular space 42 surrounds the end portion 23a of the heat-shrinkable tube 23 and has a small thickness in the radial direction.

In the present embodiment, after the preliminary step, as shown in FIG. 9A, at least an upper end side of a cover material 41M2, which is the material for the annular cover member 41 before heat shrinkage, is brought near the outer circumferential surface of the tube material 23M2 on the lower end side.

Then, the tube material 23M2 to which this cover material 41M2 is attached is placed on the stand T having the installation surface F that can be arranged in a heating environment. FIG. 9B is a bottom view of the tube material 23M2 at this time, to which the cover material 41M2 is attached.

Then, a preset injection amount of the resin solution L is injected into the tube material 23M2 placed on the stand T, from the upper end side of the tube material 23M2. After which, the exposed conductor portions 11a and 11b of the coated electric wires W1a and W1b that are connected by crimping using the crimp terminal 14 as well as the coating end portions 12a and 12b adjacent to the exposed conductor portions 11a and 11b are immersed in the resin solution L inside the tube material 23M2.

Then, in order to advance heat shrinkage of the tube material 23M2 placed on the stand T and heat-curing of the resin solution L injected into the tube material 23M2, the tube material 23M2 and the resin solution L are heated to a predetermined temperature by hot air from outside the tube material 23M2 and the cover material 41M2 in the material arrangement completed state. Alternatively, the tube material 23M2 and the cover material 41M2 placed on the stand T in the material arrangement completed state are inserted into and moved in the heating environment, and in this manner, the tube material 23M2 and the resin solution L are heated to the predetermined temperature from outside the tube material 23M2 and the cover material 41M2.

In this state, the tube material 23M2 and the cover material 41M2 are heat-shrunk such that the diameters of the entirety of the tube material 23M2 and the cover material 41M2 are reduced, and the level of the resin solution L rises.

That is to say, when heat shrinkage of the tube material 23M2 and the cover material 41M2 advances, the level of the resin solution L rises as shown in FIG. 10A. Also, as shown in FIGS. 10A and 10B, the tube material 23M2 and the cover material 41M2 become a tube material 23M3 and a cover material 41M3 having smaller diameters than the tube material 23M2 and the cover material 41M2 due to heat shrinkage, and the diameter of the annular space 42, which is formed between these materials, is also reduced. It should be noted that at this stage, although an annular space 43 is also formed between the tube material 23M2 and the cover material 41M2, or between the tube material 23M3 and the cover material 41M3, the two annular spaces 42 and 43 are in communication with each other via a space between a lower end portion of the inner circumference of the cover material 41M2 or 41M3 and the installation surface F.

On the other hand, the resin solution L, which is a two-part thermosetting epoxy resin, generates heat due to the base resin and the curing agent of the resin solution L itself reacting with each other, and is also heated from the outside. Thus, heat curing of the resin solution L of the thermosetting epoxy resin starts advancing.

When heat shrinkage of the tube material 23M3 and heat-curing of the resin solution L further advance, the level of the resin solution L further rises, and after which, heat-curing of the resin solution L advances. Moreover, the diameters of the tube material 23M3 and the cover material 31M3 are further reduced due to heat shrinkage, and the diameter of the annular space 42 formed therebetween is also further reduced.

Then, after a predetermined heating time has elapsed, the waterproofing structure having the heat-shrinkable tube 23 with the stopper 22 as well as the resin material 25 having the function of a water blocking agent for waterproofing the splice portion 10 inside the heat-shrinkable tube 23 is completed.

According to the present embodiment as well, the cover material 41M2, which is the material for the annular cover member 41, accurately keeps the vertically upright orientation of the tube material 23M2, which is the material for the heat-shrinkable tube 23, thereby preventing the tube material 23M2 from being significantly inclined during heat shrinkage.

Furthermore, in this heating stage, since not only the vertically upright orientation of the tube material 23M2 is accurately kept, but also the annular space 42 that can circumferentially uniformly keep and transfer the heat resulting from heating from outside the tube material 23M2 is formed inside the cover material 41M2, during heat shrinkage of the tube material 23M2 and heat-curing of the resin solution L, the speed of shrinkage and curing of the entirety of the tube material 23M2 and the resin solution L is stabilized.

Therefore, even if heating of the tube material 23M2, which is the material for the heat-shrinkable tube, from the outside becomes nonuniform, the occurrence of a situation in which the lower end portion of the tube material 23M2 is significantly heat-shrunk first, causing a rise in the level of the resin solution L at an early stage of the heat-shrinking stage, and a situation in which the resin solution L drips from the upper end portion of the inclined tube material 23M2 is prevented.

Thus, as in the case of the first embodiment, the occurrence of a situation in which curing is performed in a state in which a portion of the resin material 25 is dripping to the upper portion of the completed heat-shrinkable tube 23 is prevented, and the reliability of waterproofing of the splice portion 10 is stably ensured. Therefore, the same effects as those of the first embodiment are achieved.

It should be noted that in FIG. 1, the shape of the heat-shrinkable tube 23 in a stage in which heat shrinkage of the heat-shrinkable tube 23 and heat-curing of the thermosetting epoxy resin are completed is shown as a substantially straight cylindrical shape. However, a thermosetting epoxy resin that can be heat-cured faster may also be used so that the outer diameter on the end portion 23b side becomes slightly larger than the outer diameter of the end portion 23a, although the diameter of the entire heat-shrinkable tube 23 is significantly reduced relative to that before shrinkage.

As described above, the present design can provide a low-cost water blocking structure for an insulation-coated electric wire, the structure enabling a high water blocking property and favorable workability to be ensured, and a wire harness having this structure, and is therefore useful for a water blocking structure for an insulation-coated electric wire, the structure being effective when provided at an intermediate portion of the insulation-coated electric wire, as well as all wire harnesses.

As described above, the present design can provide a method and a structure for waterproofing a wire harness, the method and the structure making it possible to reliably prevent dripping of a water blocking agent from a cap-like heat-shrinkable tube and stably ensure the reliability of waterproofing with the heat-shrinkable tube and the water blocking agent. As such, the present invention is useful for all the waterproofing methods and the waterproofing structures that include blocking of water in a space between elemental wires in an exposed conductor portion of an insulation-coated electric wire of a wire harness.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for waterproofing a wire harness, the method comprising injecting a water blocking agent in liquid form into a heat-shrinkable tube with one end portion thereof closed, from another end portion side, immersing an exposed conductor portion of an insulation-coated electric wire in the injected water blocking agent in liquid form, and heating, in this state, the heat-shrinkable tube and the water blocking agent from outside the heat-shrinkable tube to heat-cure the water blocking agent while heat-shrinking the heat-shrinkable tube so that the water blocking agent and the heat-shrinkable tube surround a coating end portion of the coated electric wire,
wherein a heat-shrinkable annular cover member holding the heat-shrinkable tube so that the heat-shrinkable tube can stand upright and surrounding said one end portion side of the heat-shrinkable tube is arranged to form an annular space surrounding the one end portion of the heat-shrinkable tube inside the annular cover member, and
during heating of the heat-shrinkable tube and the water blocking agent from outside the heat-shrinkable tube, the annular cover member and the heat-shrinkable tube are heat-shrunk while the annular cover member is brought into contact with the heat-shrinkable tube.

2. The method for waterproofing a wire harness according to claim 1, wherein a two-part thermosetting epoxy resin is used as the water blocking agent.

3. A structure for waterproofing a wire harness, the structure comprising a tubular protective member and a resin material, the tubular protective member accommodating an exposed conductor portion of an insulation-coated electric wire together with a coating end portion adjacent to the exposed conductor portion, and the resin material being cured in a bottomed tubular shape in a state in which the resin material covers the exposed conductor portion and the coating end portion while being accommodated in the protective member,
wherein the protective member is constituted by a heat-shrinkable tube that is shrunk to a predetermined shrink diameter and that is closed at one end side by a stopper,
the resin material is formed of a thermosetting resin that is cured between the protective member and the coated electric wire while coming into intimate contact with the stopper and a pair of said coating end portions adjacent to the exposed conductor portion, and
an annular cover member is provided on said one end portion side of the heat-shrinkable tube, the annular cover member being integrally heat-shrunk with the heat-shrinkable tube so as to form an annular space that surrounds said one end portion of the heat-shrinkable tube, while holding the heat-shrinkable tube so that the heat-shrinkable tube can stand upright.

4. The structure for waterproofing a wire harness according to claim 3,
wherein the resin material is formed of a cured layer of a two-part thermosetting epoxy resin, and
the heat-shrinkable tube is formed such that a width of the annular space in a radial direction becomes smaller on an upper end side of the annular cover member and larger on a lower end side of the annular cover member.
